(19) United States
(12) Patent Application Publication
(10) Pub. No.: US 2014/0007635 A1
(43) Pub. Date: Jan. 9, 2014

(54) PRESSURE VESSEL AND HIGH-PRESSURE PRESS

(71) Applicants: Mats Gardin, Vasteras (SE); Lennart Svensson, Vasteras (SE)

(72) Inventors: Mats Gardin, Vasteras (SE); Lennart Svensson, Vasteras (SE)

(73) Assignee: AVURE TECHNOLOGIES AB, VASTERAS (SE)

(21) Appl. No.: 13/978,602

(22) PCT Filed: Jan. 7, 2011
(86) PCT No.: PCT/EP11/50164

§ 371 Date: Sep. 24, 2013

(51) Int. Cl. F17C 1/06; B21D 26/02

(52) U.S. Cl. CPC F17C 1/06; B21D 26/02
USPC 72/54; 220/586; 220/692

(57) ABSTRACT

The present invention relates to a pressure vessel and a pressing arrangement comprising such a pressure vessel, for use at high-pressure pressing. The pressure vessel comprises a pressure chamber arranged for accommodating a pressure medium is provided. The pressure vessel comprises one or several cylinder segment/segments arranged to form a pressure vessel cylinder surrounding the pressure chamber, whereby a joint is formed at adjacent longitudinal edges of the cylinder segment/segments. Prestressing means are provided around an outer envelope surface of the pressure vessel cylinder for radially prestressing the pressure vessel cylinder. Each joint at adjacent edges of the cylinder segment or segments has a continuous extension along the longitudinal length of the pressure vessel cylinder.

### TECHNICAL FIELD

The present invention relates to a pressure vessel and a press comprising such a pressure vessel, for use at high-pressure pressing.

### BACKGROUND OF THE INVENTION

A high-pressure press manufacturing or processing method may use fluid pressurized to a very high-pressure. Various types of presses are used in various applications. For example, highly pressurized fluid may be provided in a closed pressure vessel and used as an exerting force onto an intermediate diaphragm or the like to form sheet metal parts into predetermined shapes. In other examples, highly pressurized fluid is provided in a pressure vessel for isostatic pressing of articles, such as for compaction or densification of metallic or ceramic powders, reduction of pores or voids in castings or sintered articles, sterilization, preservation of food stuffs, etc. Within the art, reference is often made to hot isostatic pressing (HIP), warm isostatic pressing (WIP) and cold isostatic pressing (CIP), depending on the temperature of the pressure medium during the pressing process.

A pressure vessel in a conventional high-pressure press comprises a pressure vessel cylinder and closure lids. Between pressing operations, one or both of the lids may be opened, depending on the configuration and design of the press. Together, the lids and the pressure vessel cylinder define the internal dimensions and volume of the pressure chamber, i.e. the pressure pressing capacity, where the actual pressing or forming process is taking place. In addition, a conventional high pressure press normally comprises a frame for holding the lids and for absorbing axial forces. When the lid or lids are in closed and sealed state, the pressure vessel is filled with a fluid pressure medium, i.e. liquid or gas. The frame fixes and locks the lid to the pressure vessel, wherein the press cylinder and lids may have a large weight and they may be subjected to high-pressure. The press also includes a pressure generating arrangement, e.g. a pump system, for providing pressure media to the pressure vessel, e.g. via pressure medium connections, and to raise the pressure in the chamber to operating pressures.

Regarding the level of pressure in the chamber, this mainly depends on the press type and the material to be pressed. For example, in sheet metal forming presses the pressure inside the pressure vessel may be raised to pressures of about 80 or 140 MPa. In other presses, such as isostatic presses, the pressures can reach up to 200 MPa (hot) or 600 MPa (cold). The presses operational at such pressure levels are often referred to as high-pressure presses.

Pressure vessel cylinders for high-pressure pressing have traditionally been manufactured by casting followed by forging. In some cases, a compact, cylinder blank is first cast. Thereafter, the cylinder blank is provided with central through-going hole. The cylinder blank is then forged, i.e. a rough pressure vessel cylinder is first cast, which subsequently is forged to expand into a hollow pressure vessel cylinder of suitable diameter and wall thickness. The forging process increases the strength of the cast material. Finally, in order to withstand high internal pressures, the pressure vessel cylinder is prestressed, meaning that means are provided which radially compress the cylinder. Thereby the cylinder wall is subjected to tangential compressive stresses. Prestressing also minimizes the risk of crack formation/propagation in the cylinder wall and, hence, reduces the risk of pressure vessel failure.

Within the business of high-pressure pressing, the requirements as to sizes of articles to be subjected to high-pressure pressing, as well as the batch volumes are continuously increasing. Furthermore, there is a continuous demand for increased throughput and shortened cycle times. As a result, a great demand for larger pressing volumes exist within the art, which must be met by increasing the volumes of the pressure chambers, often beyond what is possible with the pressure vessels of today. In addition, the conventional production method described above is complex and time consuming. This in combination with the limited number of qualified supplier's causes problems regarding long times of delivery. Hence, there is a need of improved pressure vessels and, particularly, for pressure vessels that is capable of coping with the continuously increasing requirements and demands of the business and customers.

### SUMMARY OF THE INVENTION

An object of the present invention is to provide an improved a high-pressure arrangement.

This and other objects are achieved by providing a pressure vessel, a high-pressure press for isostatic pressure treatment of articles, and a press of pressure cell type for pressure forming of articles according to the independent claims. Example embodiments are defined in the dependent claims.

According to a first aspect of the invention, a pressure vessel comprising a pressure chamber arranged for accommodating a pressure medium is provided. The pressure vessel comprises one or several cylinder segment/segments arranged to form a pressure vessel cylinder surrounding the pressure chamber, whereby a joint is formed at adjacent longitudinal edges of the cylinder segment/ segments. Prestressing means are provided around an outer envelope surface of the pressure vessel cylinder for radially prestressing the pressure vessel cylinder. Each joint at adjacent edges of the cylinder segment or segments has a continuous extension along the longitudinal length of the pressure vessel cylinder.

According to a second aspect of the invention, there is provided a high-pressure pressing arrangement for isostatic pressure treatment of articles. The press comprises a pressure vessel according to the first aspect and a force-absorbing press frame provided around the pressure vessel cylinder.

The invention is based on the insight of providing and using a radially prestressed and segmented pressure vessel cylinder, where the pressure vessel cylinder is segmented or divided essentially along the length of the cylinder into segments, each having a cylinder length extension, for providing a pressure vessel in a pressure press machine. The use of such cylinder segments makes possible cylindrical pressure vessels of larger dimensions than what, in practice, is suitably possible today. Furthermore, it also provides significant advantages in transporting the pressure vessels to the assembly site, i.e. the pressure vessel can be transported in segments from the forger or the like, to the manufacturing and assembly site.

According to the present invention, a cylinder can be formed, for example forged, from an originally planar metal plate. Thus, a single planar element can be shaped, for example by bending, to a single cylindrical body or pressure vessel cylinder, wherein first and second longitudinal edges of the plate will arrive in a position where they are adjacent each other. It is also possible to form several cylinder segments from metal plates and arrange them to form a pressure vessel cylinder. Such curved cylinder segments can also be cast as segment blanks and then be forged into their final shape. According to the invention, the cylinder segments can in some cases be directly cast into their final curved shape and thereafter, if necessary, be given additional strength by forging.

A benefit of the pressure vessel in accordance with the present invention is thus that the process of forming large cylinders to be used as pressure vessels is significantly facilitated. This makes it easier to produce larger pressure vessels for accommodating a larger amount of pressure medium. Thereby, pressure vessels, for high-pressure pressing processes, can be produced with dimensions that can simply not be cast and forged with conventional process techniques by the forgers in operation today. Also, the provision of the pressure vessel cylinder being produced from separate segments, or portions, greatly increases the number of available metal works that can produce cylinder bodies for pressure vessels than what is the case today. Thereby, the waiting time between order and delivery of a pressure vessel cylinder for large high-pressure presses can advantageously be reduced, thereby reducing manufacturing costs. Another great advantage is that larger objects than what is possible today can be placed inside the pressure vessel and shaped by a pressure press forming process or an isostatic pressing process. Of course, larger batches of articles can alternatively be positioned within the pressure chamber and treated in a single treatment cycle, thereby advantageously increasing the throughput for a single high-pressure press.

Another advantage of a pressure vessel of the present invention, is that the cylinder segments, being smaller and lighter in weight than an aggregate pressure vessel cylinder, enables local production of the pressure vessel cylinder, e.g. at a site near the plant at which assembly of the pressure vessel and/or the pressure pressing apparatus is performed. This may reduce or even substantially remove the costs related to transporting of large prior art cylinder bodies, due firstly to the shorter distance between the site at which the segments are produced to the assembly site, and secondly to the simplified transportation process for moving a large number of small and light pieces in comparison with moving a large and heavy piece. Alternatively, the pressure vessel cylinder may also be built directly at the site where it is to be used, thereby lowering the transport costs even further.

It should be noted that a pressure vessel according to the present invention may be used in a number of different pressure pressing apparatuses of various dimensions and for various operating pressures.

A cylinder, as used herein, generally refers to an elongated cylinder body of substantially circular cross-dimension, having a cylindrical cavity and cylinder walls with substantially constant thickness. In the context used herein, the “cylinder” is an open-ended body, even though, during operation of the pressure vessel, the cylinder may be provided with end closures or lids, at least one of which being arranged for opening and closing the pressure vessel.

The term“cylinder segments” refers to portions or parts of a cylinder body (i.e. the pressure vessel cylinder) when mounted together or assembled form an entire cylinder body. The engaging surfaces or edges of adjacent cylinder segments can in embodiments of the invention be essentially planar and parallel to the longitudinal axis of the assembled cylinder. That is, the joints between adjacent cylinder segments may have an essentially straight extension in parallel with the pressure vessel cylinder. These segments are easily assembled, and engagement between adjacent segments is reinforced by applying a radial pressure onto the outer surface of the pressure vessel cylinder, such as through prestressing means. Forces acting to separate the segments, i.e. a radial component from the internal pressure of the pressure chamber are counter-balanced by radial forces acting on the outer surface of the pressure vessel cylinder by the prestressing means.

According to one embodiment of the invention, the pressure vessel cylinder comprises a single cylinder segment. This segment can be manufactured from a planar or curved metal plate. The metal plate can be cast, rolled or produced using any other suitable method. The plate, or in other words, the segment blank, can have an overall rectangular figuration with two longitudinal edges. The blank is then shaped, for example bent, to form a pressure vessel cylinder with the longitudinal edges adjacent and possibly contacting each other.

In other embodiments, the single segment or the several segments are provided with an essentially helical shape, i.e. the joints between adjacent cylinder segments edges extend from one end of the cylinder to the other along a helical path in the cylinder walls.

By having cylinder segments or portions extending from one end of the cylinder to the other, the longitudinal force components arising from the internal pressure within the pressure chamber, only acts to separate the end closures from the cylinder and not the cylinder segments from each other. Thereby, the radial prestress of the prestressing means provided around the outer envelope surface of the pressure vessel cylinder is sufficient for counteracting pressure forces from within the pressure vessel acting to separate the cylinder segments.

There exists several pre-stressing methods within the art, such as wire-winding, autofrettage, shrinkage, etc, which will be discussed further below. It should be noted that the present invention is by no means restricted to one such prestressing method.

Wire-winding involves tightly winding wires or bands onto and around the outer surface of the pressure vessel cylinder of the pressure vessel. During winding, the wires or bends are stretched such that a prestress is induced in the wires and bands, which provides radial, inward forces acting on the pressure vessel cylinder and induce a prestress thereto. A wire is generally made of metal and may be of different cross-sectional shapes, such as circular, elliptical or rectangular. Thus, tightly wound prestressed wires around the operable pressure vessel will place the pressure vessel in a compressed and prestressed state.

Another pre-stressing method is the shrinkage method. A cylinder with a given natural outer diameter is thermally shrunk, reducing said diameter, and placed inside another cylinder with an inner diameter that is slightly less than said natural outer diameter of the inner cylinder. The outer cylinder then exerts an inward radial force onto the envelope surface of the inner cylinder, thereby prestressing the inner cylinder and placing it in a compressed state. The shrinkage prestressing method could also be performed by heating the outer cylinder, thereby expanding the inner diameter thereof beyond the natural outer diameter of the inner cylinder, assembling the cylinders, and allowing the outer diameter to cool, resulting in a reduction of the inner and outer diameter of the outer cylinder, i.e. a shrinkage.

In a further method known as autofrettage, the material is strained beyond its elastic limit, or yield point, into plastic deformation, e.g. by mandrelling. According to this method, the pressure inside a pressure vessel is raised such that the inner wall surface starts to deform and enter the state of plastic deformation. Then, the pressure is released, creating a prestressed pressure vessel. However, in this method it may be difficult to control the level of prestressing.

According to embodiments of the invention, the prestressing means is arranged for prestressing the pressure vessel cylinder to a level of full prestress. In a fully prestressed pressure vessel cylinder, the level of prestress of the cylinder wall is such that the wall of the cylinder will be subjected to tangential compressive stress during working or operating pressures, which tangential compressive stress is larger than the working or operating pressures in the pressure chamber. This reduces the risk of failure of the pressure vessel. This is due to the fact that even if a crack is formed in the wall or if pressure medium was to enter between two adjacent cylinder segment edges, the prestressing forces exceed the tangential expanding forces created by the pressure medium under high pressure. This also applies even under maximal operating pressure of the pressure vessel. Thus, the prestressing of the pressure vessel cylinder results in the shape of the cylinder being maintained even if a crack is present in the cylinder wall. Moreover, crack propagation is impeded. Thereby the risk of pressure vessel failure is considerably reduced.

According to other embodiments, the pressure vessel cylinder is prestressed to a lesser level, for example to a level where the cylinder segment wall during maximal operating pressure in the pressure chamber will experience a positive tangential compressive stress. A prestress to this level is sufficient to prevent separating tensile stress in a cylinder segment wall up to the maximal operating pressure.

According to embodiments of the present invention, the prestressing means comprises prestressing sheet elements, having a width essentially equal to the cylinder length, which is circumferentially wound around the envelope surface of the cylinder in at least one layer, preferably more. The sheet is preferably wound a number of windings around the pressure vessel cylinder, thereby forming a prestressing section having a plurality of layers. Also, a plurality of sheets, each extending the length of the cylinder, may be joined to form additional prestressing layers.

In yet further embodiments, the prestressing means comprises a plurality of substantially narrow prestressing elements in the form of bands or wires, having, e.g., a circular, elliptical, square or rectangular, or similar cross-sectional shape. Preferably, the bands or wires have a breadth that is significantly less than the length of the cylinder. The bands or wires are wound in a helical manner from one end of the cylinder to the other, and back. Each winding from one end to the other forms a separate prestressing layer and the pre-stressing arrangement is preferably comprised of a plurality of layers.

Furthermore, the at least two cylinder segments making up the force-absorbing pressure vessel cylinder, or the adjacent edges of the single pressure vessel cylinder in corresponding embodiments, may, in some embodiments, be interconnected, at least in part, along longitudinally extending adjacent surfaces. Preferably, the joining of the segments is performed by welding or brazing or soldering, for instance laser welding, arc welding, plasma welding, TIG welding, MAG welding, etc. These interconnections normally make only a minor contribution to holding the segments together during operation, which is achieved by the prestressing means, but an advantage with this embodiment is that the pressure vessel cylinder is held together during mounting and wire winding. Another advantage is that the weld or soldered joint can function as a sealing for preventing leakage of pressure media between adjacent longitudinal edges.

According to other embodiments of the present invention, there are no connecting means at the joints, but the cylinder segments, or in the corresponding embodiment, the adjacent edges of the single cylinder segment, are held together by the prestressing means only. Thus, the joint constitutes the abutting surfaces of the adjacent longitudinal cylinder segment edges. These edges are pressed together such that a force-absorbing pressure vessel cylinder is achieved by the pressure vessel cylinder and the prestressing means applied around an envelope surface of the pressure vessel cylinder. In these embodiments, a desired sealing between adjacent cylinder segments can be achieved and/or enhanced by means of, for example, gluing.

Anyone of embodiments discussed above and illustrated in the appended figures may advantageously be combined with anyone of the embodiments described the co-pending application “Welded sealing of pressure cylinder vessel” by the same applicant, which hereby are incorporated herein by reference.

Moreover, in embodiments of the pressure vessel of the present invention, the pressure vessel is operable within the pressure range of about 10 to about 600 MPa, and more preferably, within the pressure range of about 20 to about 300 MPa, and even more preferably within the pressure range of about 20 to about 150 MPa. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed description, the attached dependent claims, and from the appended drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 form a schematical illustration of a force-absorbing pressure vessel cylinder according to one embodiment of the present invention;

FIG. 2 form a schematical illustration of a force-absorbing pressure vessel cylinder according to another embodiment of the present invention;

FIG. 3 is a schematical illustration of a pressure vessel including the pressure vessel cylinder of FIG. 1;

FIG. 4 is a schematical illustration of a force-absorbing pressure vessel cylinder comprising a single cylinder segment according to an embodiment of the present invention;

FIGS. 5a-5e is a schematical illustration of how a pressure vessel of FIG. 3 can be manufactured;

FIGS. 6a and 6b are two schematical illustrations of force-absorbing pressure vessel cylinders according to further embodiments of the present invention; and

FIG. 7 is a schematical illustration of a high-pressure press comprising a force-absorbing pressure vessel cylinder according to embodiments of the present invention.

FIG. 8 is a schematical illustration of a pressure vessel according to a further embodiment of the present invention.

FIG. 9 is a schematical cross-section view of the pressure vessel shown in FIG. 8.

### DETAILED DESCRIPTION OF THE PREFERRED EMBODIMENTS

The invention is mainly described with reference to a few embodiments. However, as is readily appreciated by a person skilled in the art, other embodiments than the ones disclosed are equally possible within the scope of the invention, as defined by the appended claims.

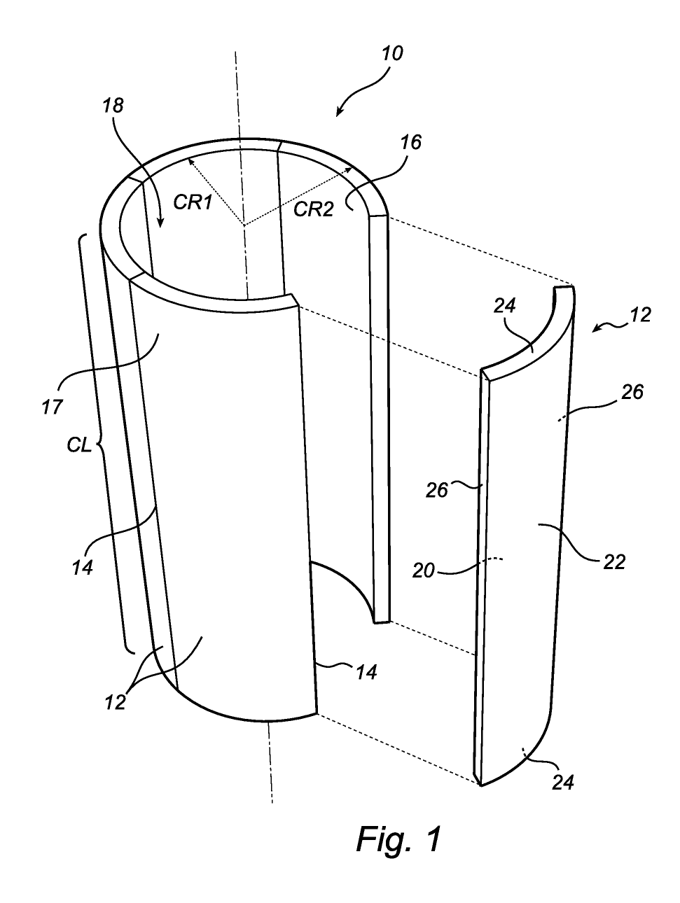

With reference to FIG. 1, there is schematically shown an illustration of a force-absorbing cylinder body or pressure vessel cylinder 10 according to an embodiment of the present invention. According to the embodiment illustrated in FIG. 1, the pressure vessel cylinder 10 comprises five cylinder segments or wall sections 12. At adjacent longitudinal edges of the cylinder segments 12 are joints 14. The pressure vessel cylinder 10 has a cylinder length CL, a first cylinder radius CR1 from the cylinder axis, through the centre of the pressure vessel cylinder 10, to an inner surface 16 of the pressure vessel cylinder 10, and a second radius CR2 from CA to an outer surface or envelope surface 17 of the cylinder segments 12. Each and every interconnection/joint 14 between the segments 12 lie essentially in parallel with the cylinder axis and extends the entire cylinder length CL. Moreover, when assembled the inner surfaces 16 of the cylinder wall segments 12 define a pressure chamber 18.

The joint 14 comprises the abutting flat, cylinder length long edges 26 of the segments 12, which abutting, adjacent edges lie in a plane (not illustrated). All these interconnection planes intersect the centre axis of the pressure vessel cylinder 10. At the top and bottom of the segment 12, there is one end edge 24, respectively, also these have flat surfaces. All flat top end edges forms a common plane, i.e. the segments are leveled. Likewise are the flat bottom end edges. The segments 12 also have an outer surface 22, which constitute a part of the envelope surface 17. An inner segment surface 20 constitutes a part of the inner cylinder surface 16, which defines the pressure chamber 18.

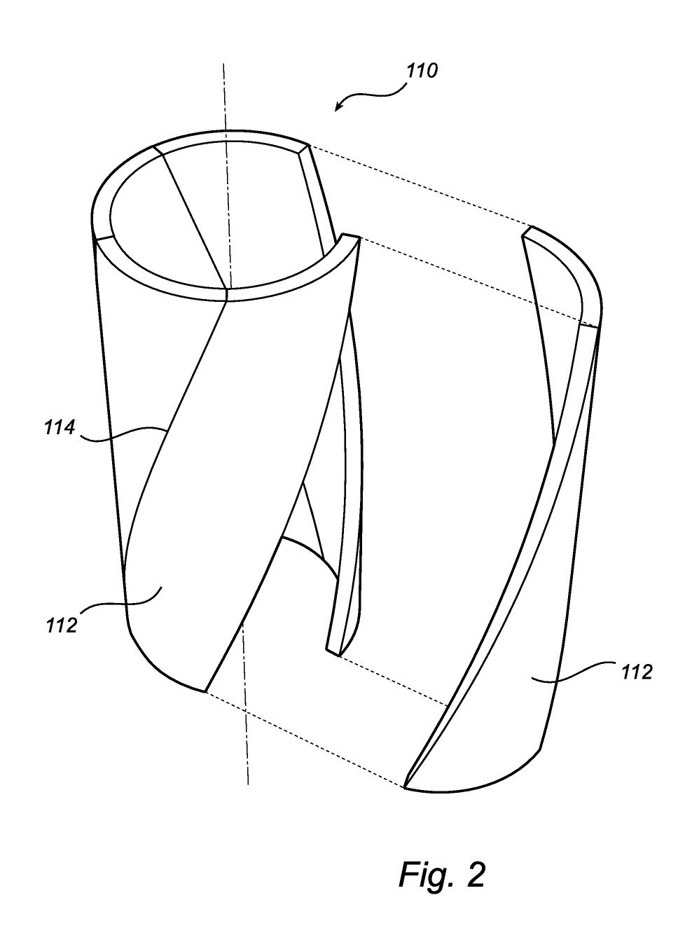

FIG. 2 shows another example embodiment of a pressure vessel cylinder 110 according to the present invention. The interconnections/joints 14 of the force-absorbing pressure vessel cylinder in FIG. 2 runs from one end of the cylinder along the cylinder length to the other end of the cylinder in a helical manner. Thus, the segments 12 of the cylinder have another shape. As is understood, the shape of the segments 12 may have any geometric shapes, for example a triangular, as long as they extend the entire cylinder length CL.

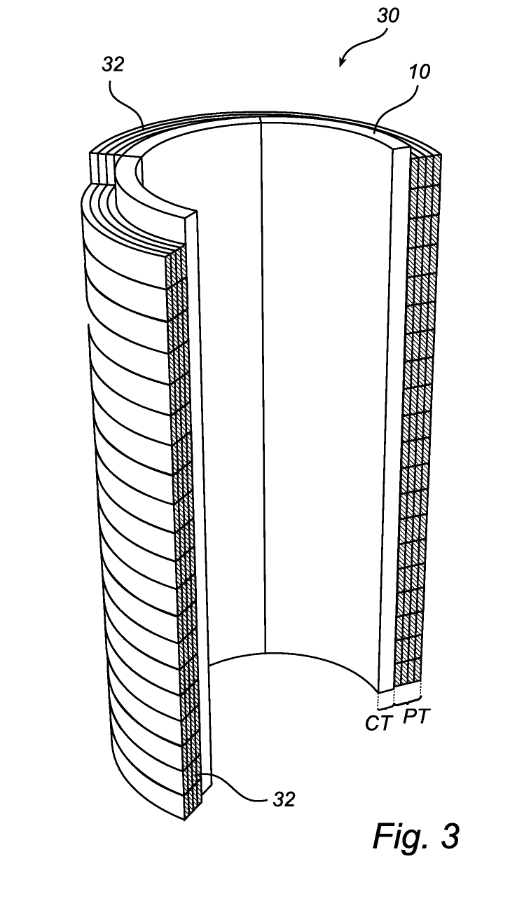

FIG. 3 is a cross-sectional view of a pressure vessel 30 along a centre axis. A prestressing means 32 surrounds the pressure vessel cylinder 10. Although FIG. 3 shows that the prestressing means 32 cover the entire cylinder envelope surface, it is understood that the prestressing means may cover only a part thereof, though at least a circumferential portion. Here, the prestressing means is in the form of a band or flat wire. Also indicate in FIG. 3 are the thickness of the cylinder wall CT and the prestressing band PT.

In the described embodiments of the present invention, there are no connecting means at the joints between adjacent cylinder segments. The five cylinder segments are held together by the prestressing band. However, in other embodiments, the segments 12 can be fixed together at the joints 14 with various methods, depending for example on the material of the force absorbing pressure vessel cylinder 10. If the segments 12 are made of a material such as metal, the segments 12 are preferably welded together with an arbitrary welding technique. Gluing is another alternative. While these interconnections will not essentially contribute to holding the segments together during operation, this is achieved by the prestressing means, but they are advantageous in that the pressure vessel cylinder is held together during mounting and installation. However, if the segments are welded, soldered, brazed or glued together, an enhanced sealing between adjacent cylinder segments can be achieved.

Turning now to FIG. 4, a further embodiment of the present invention will be discussed. According to this embodiment, a pressure vessel cylinder 210 is formed of one cylinder segment 212 shaped to a cylindrical body. A first and a second longitudinal edge 226a and 226b will thus abut each other in when mounted together to form the pressure vessel cylinder 210. When assembled, the cylinder segments 212 define a pressure chamber 218. The pressure vessel cylinder 210 has a cylinder length CL, a first cylinder radius CR1 from the cylinder axis, through the centre of the pressure vessel cylinder 10, to an inner surface 16 of the pressure vessel cylinder 210, and a second radius CR2 from CA to an outer surface or envelope surface 17 of the cylinder segments 12.

In the described embodiment, there are no connecting means at the joint between the longitudinal edges 226a and 226b. The cylinder shape is maintained by the prestressing band, see FIG. 3. However, in other embodiments, the longitudinal edges 226a and 226b can be fixed together with various methods, depending for example on the material of the pressure vessel cylinder 210. If the segment 212 comprises a metal material, the longitudinal edges 226a and 226b are preferably welded together with an arbitrary welding technique. Gluing is another alternative. While these interconnections will not essentially contribute to holding the segments together during operation, this is achieved by the prestressing means, but they are advantageous in that the pressure vessel cylinder is held together during mounting and installation. However, if the segments are welded, brazed, soldered or glued together, an enhanced sealing between adjacent cylinder segments can be achieved.

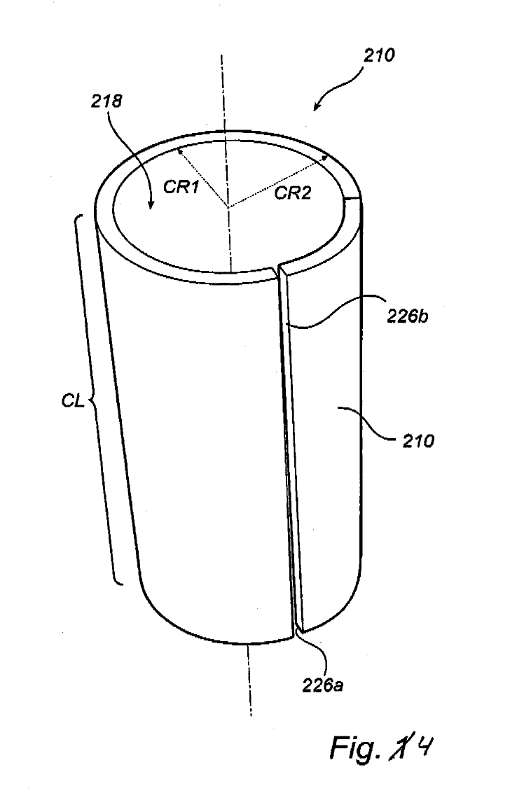

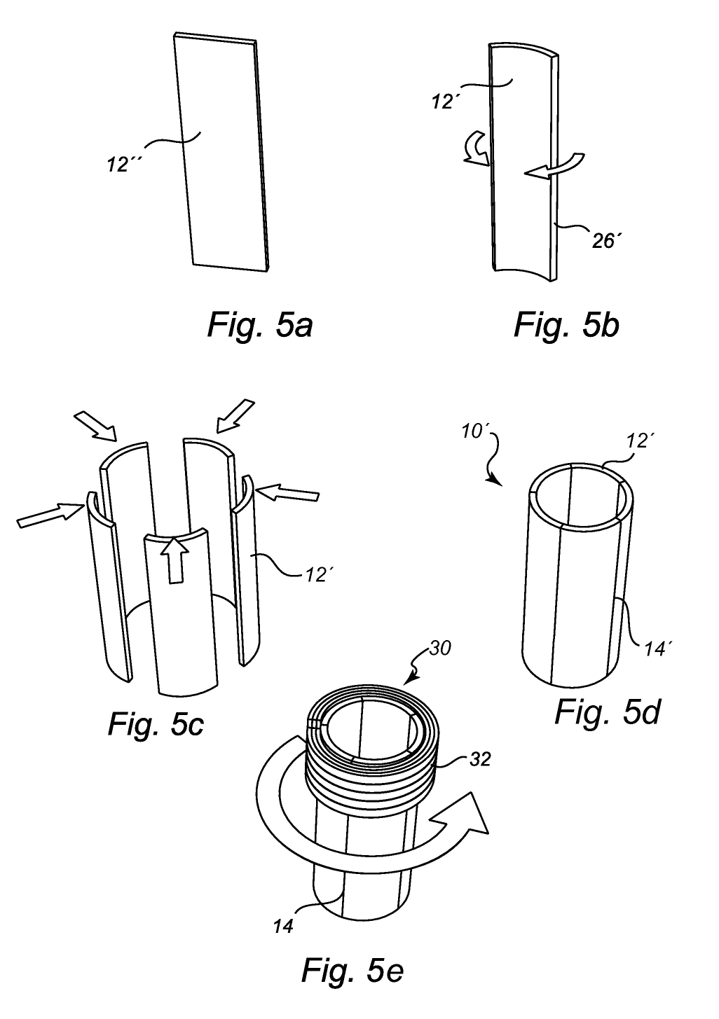

FIGS. 5a-5e schematically illustrate a manufacturing method related to at least one embodiment of the present invention. Preferably, the segment/-s 12, 112, 212 is/are produced as planar metal plates using any suitable method such as casting or rolling, possibly involving cutting to suitable size. The rectangular pieces 12″, or in other words, cylinder segments blanks, are then bent to form longitudinal wall segments 12′ of the pressure vessel cylinder 10′ using any suitable method, such as bending or forging. FIG. 5b illustrates the step of bending the piece 12″into a bent piece 12′, which is necessarily not the final cylinder wall segment 12. This piece 12′ may later be adjusted, for a better fit between all the pieces of the cylinder. The bent piece 12′ has two interconnection edges 26. These edges 26′ are not essentially the same flat longitudinal edges shown in FIG. 1, because they may need further machining. Uneven edges can be made flat either by cutting a new edge surface or by grinding. FIG. 5c shows how the bent pieces 12′ or the segments 12′ are put together and arranged around a pressure chamber to form the pressure vessel cylinder 10′. In FIG. 5d, a pressure vessel cylinder 10′ where the segments 12′ have been joined or interconnected at joints 14 by means of a welding procedure to provide a sealing. For example, by means of laser welding, arc welding, plasma welding, TIG welding, MAG welding, etc. As mentioned above, brazing or soldering can alternatively be used. FIG. 5e illustrates the step of prestressing the pressure vessel 30′ with prestressing means 32. Here, the prestressing means comprises a plurality of wiring elements.

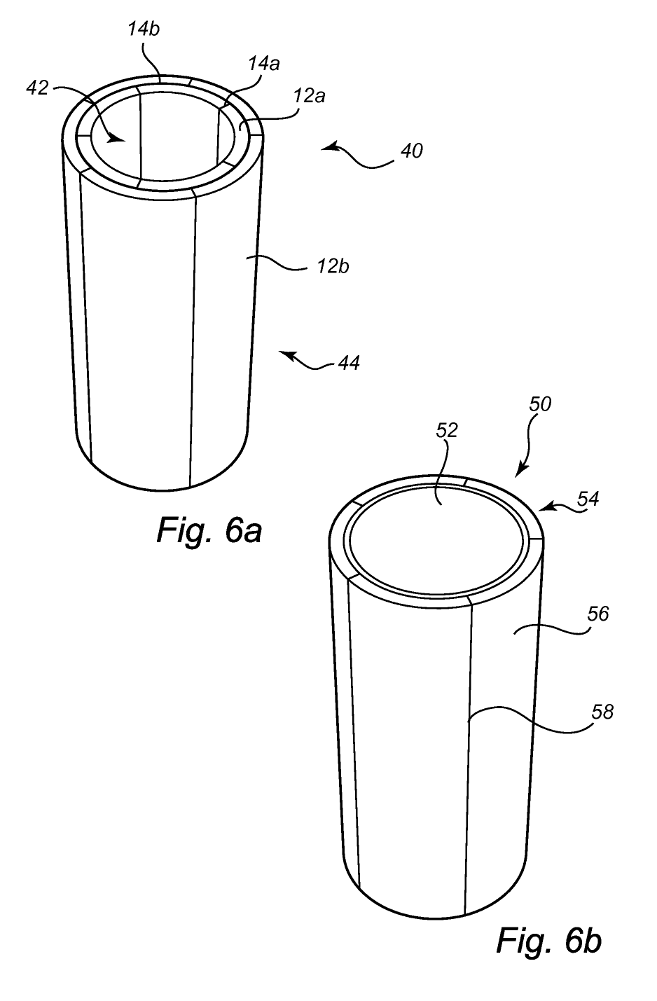

FIG. 6a shows an alternative embodiment of the pressure vessel illustrated FIG. 1. The pressure vessel cylinder 40 comprises segments 12a, 12b arranged in two layers. This multilayer pressure vessel cylinder 40 comprises a first inner cylinder 42 comprising five cylinder segments 12a. A second outer cylinder 44 is arranged outside the first inner cylinder 42. Preferably, interconnections 14a of the first cylinder 42 are misaligned to interconnections 14b of the second cylinder 44. The segments of both cylinders 42, 44 can be interconnected according to any method described above. Also, a combination of two different methods can be used. For example, the first inner cylinder body 42 may be interconnected and held together only by the second outer layer 44. Moreover, the second cylinder body 44 may be interconnected by welding. Consequently, the second cylinder 44 may acts as a pre-stressing means for radially prestressing the inner cylinder 42. It is to be understood that further cylinder bodies may be surround the second cylinder bodies. Finally, the envelop surface of the outermost cylinder will be provided with a pre-stressing means such as layers of wound steel bands.

In FIG. 6b, there is shown a pressure vessel cylinder 50 provided with an inner liner 52. An outer cylinder 54 formed of cylinder segments 56 in accordance with, for example, the embodiment described above with reference to FIG. 1 is arranged to encase the inner liner 52. This embodiment is advantageous with respect to sealing of the joints 58 between adjacent segments 54. It is also conceivable to encase an inner cylinder formed of cylinder segments with an outer liner, an embodiment which however is not illustrated. This conceivable embodiment is also advantageous with respect to enhanced sealing of the joints between adjacent segments.

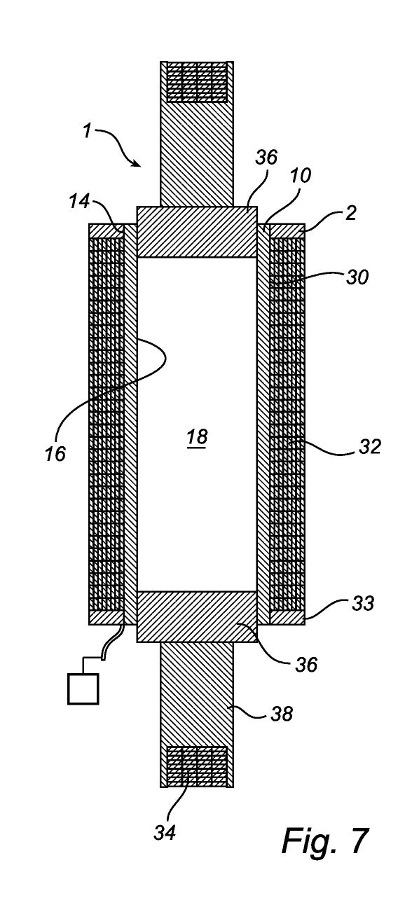

With reference to FIG. 7, there is schematically shown an illustration of an isostatic pressing arrangement according to a further example embodiment of the present invention. The pressing arrangement 1 comprises a pressure vessel according to the present invention, for example, the pressure vessel 30. The pressure vessel cylinder 10 has an outer envelope surface 17 and an inner surface 16. The inner surface 16 defines a generally cylindrical delimitation of a pressure chamber 18 in which substance are to undergo pressure treatment. The pressure chamber 18 is also delimited by two end closures 36.

Substances are introduced into the pressure chamber 18 by removing one of the end closures 36. Next, the end closure 36 is returned into place and a pressure medium, such as water, is supplied from a pump through conduits (not illustrated) leading into the pressure chamber 18, e.g. via one of the end portions of the isostatic press 1. When the pressure chamber 18 is filled with pressure medium, more pressure medium is introduced in order to increase the pressure to a desired high-pressure state. When the treatment is finished, the pressure chamber 18 is decompressed and the end closure 36 is removed so that the treated substances can be taken out from the pressure chamber 18 and thereby allowing new substances to be introduced.

In order to assist the pressure vessel 30 in taking up axial loads and to hold the lids closed during operation, the pressure vessel 30 is provided with a surrounding force-absorbing frame 38.

The bands 32 of the pressure vessel 30 are wound tightly, substantially in circles, around the envelope surface 17 so as to provide a radial compressive prestress in the pressure vessel cylinder 10. The band package 32 has a longitudinal extension essentially equal to the length of the pressure chamber 18, i.e. the distance between the end closures 36, and is delimited by two collars 33 arranged in respective circumferential recesses. As illustrated in the figure, the frame 38 may also be provided with a package of wound steel bands 32.

An alternative way of prestressing the pressure vessel to take up the radial loads is to use a further cylinder with a slightly smaller inner diameter compared with the outer diameter of the pressure vessel cylinder 10. That is, using a method of shrinking. The autofrettage method can also be used. These two alternative methods have already been explained in the background of the invention.

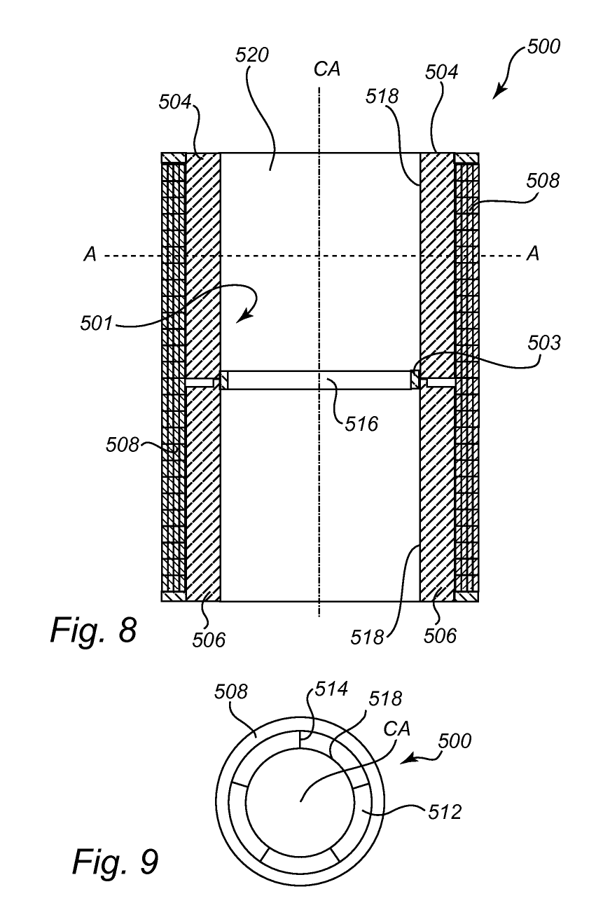

With reference now to FIGS. 8 and 9, yet another embodiment of the present invention will be discussed. Anyone of embodiments discussed herein and illustrated in the appended figures may advantageously be combined with anyone of the embodiments described the co-pending application “Welded sealing of pressure cylinder vessel” by the same applicant, which hereby are incorporated herein by reference. In FIGS. 8 and 9, one conceivable embodiment of such combination is schematically illustrated. FIG. 9 is a schematic cross-sectional view of the pressure vessel cylinder shown in FIG. 8 along a cross-section indicated with the line A-A in FIG. 8.

A pressure vessel cylinder 500 comprises two connected sub-cylinders 504 and 506, wherein each sub-cylinder 504 and 506, in turn, comprises one or more cylinder segments 512 formed to a cylinder in accordance with any one of the embodiments disclosed herein. In this illustrated embodiment of the present invention, each sub-cylinder 504, 506 comprise five cylinder segments 512 arranged to form the respective cylinders 504, 506. However, it is of course conceivable to construct a sub-cylinder of, for example, one cylinder segment or four cylinder segments. Furthermore, it is also conceivable to construct a pressure vessel using more than two sub-cylinders, for example, three or four sub-cylinders.

In this embodiment the pressure vessel 500 comprising a pressure vessel cylinder 501 comprises two sub-cylinders and ten cylinder segments or wall sections 512, five in each sub-cylinder 504, 506. At adjacent longitudinal edges of the cylinder segments 512 are joints 514. Each interconnection/joint 514 between the segments 512 lie essentially in parallel with the cylinder axis CA and extend the entire sub-cylinder length. Moreover, when assembled together the inner surfaces 518 of the cylinder wall segments 512 define a pressure chamber 520.

Further, the pressure vessel cylinder 501 is closed at the ends by lids (not shown) which are held in place by a framework (not shown).

The outer envelope surface of the pressure vessel cylinder 501 is provided with a pre-stressing means in the form of a package of wound steel bands 508. The bands are wound tightly radially around the envelope surface of the pressure vessel cylinder 501 to provide a radial compressive stress in the pressure vessel wall. The band is wound, for example, in a helical manner from one end of the cylinder to the other and back. The bands have a rectangular cross-sectional shape and are wound edge to edge. Each winding from one end to the other forms a separate pre-stressing layer, and the entire pre-stressing means comprise several layers of wound steel bands.

The framework may also be provided with a package of wound steel bands (not shown) to assist the framework in taking up axial loads. To open the pressure cylinder vessel 501, the framework and/or the sub-cylinders 504, 506 is/are moved relatively to each other in the direction perpendicular to the axial direction of the sub-cylinders 504, 506.

The two sub-cylinders 504, 506 are axially connected by a weld 516 running along the inner wall of the pressure vessel cylinder 501, thereby providing a sealing arrangement which seals a joint 503, i.e. where the sub-cylinders are connected and in contact with each other, between the two sub-cylinders 504, 506. Although not shown, it is understood that the weld 516 can extend into the pressure vessel cylinder 501. Preferably, the sub-cylinders 504, 506 are formed first in accordance with the description herein, which entails that the sub-cylinders 504, 506 thereafter can be assembled in accordance with, for example, the description in the co-pending application “Welded sealing of pressure cylinder vessel” to form the pressure vessel cylinder 501. Further advantages and design and construction details of the sub-cylinders are described thoroughly in the the said co-pending applications by the same applicant, which hereby is incorporated herein by reference.

Although an exemplary embodiment of the present invention has been shown and described, it will be apparent to those having ordinary skill in the art that a number of changes, modifications, or alterations to the invention as described herein may be made. Thus, it is understood that the above description of the invention and the accompanying drawing is to be regarded as a non-limiting example thereof and that the scope of the protection is defined by the appended claims.

1. A pressure vessel enclosing a pressure chamber, comprising
one or several cylinder segment/segments arranged to form a pressure vessel cylinder, whereby a joint is formed at adjacent longitudinal edges of the cylinder segment/segments;
prestressing means provided around an outer envelope surface of the pressure vessel cylinder for radially prestressing the pressure vessel cylinder, wherein
each said joint at adjacent edges of the cylinder segment or segments has a continuous extension along the longitudinal length of the pressure vessel cylinder.

2. The pressure vessel of claim 1, wherein said pre-stressing means is arranged for prestressing the pressure vessel cylinder to a level where the resulting stress in a circumferential direction in the cylinder segment or segments during maximal operational pressure in the pressure chamber is a compressive stress.

3. The pressure vessel of claim 2, wherein said pre-stressing means is arranged for prestressing the pressure vessel cylinder to a level where the resulting stress in a circumferential direction in the cylinder segment or segments during maximal operational pressure in the pressure chamber is a compressive stress that is equal or larger than the maximal operational pressure in the pressure chamber.

4. The pressure vessel of claim 1, wherein the prestressing means comprises one or more cylinders which is/are shrunk fit onto said pressure vessel cylinder.

5. The pressure vessel of claim 1, wherein the prestressing means is band or wire shaped, having a round, square, or rectangular cross-sectional shape, and is wound around said outer envelope surface.

6. The pressure vessel of claim 1, wherein at least two, preferably in the range of four to eight, cylinder segments are arranged to form the pressure vessel cylinder.

7. The pressure vessel of claim 1, wherein the adjacent longitudinal edges of the at least one cylinder segments have been joined by welding. brazing, or soldering.

8. The pressure vessel of claim 1, wherein each said joint extends along at least a portion of the perimeter of the pressure vessel cylinder essentially parallel to the longitudinal axis thereof.

9. The pressure vessel of claim 1, wherein each said joint extends along the perimeter of the pressure vessel cylinder essentially helically and co-axially to the longitudinal axis thereof.

10. The pressure vessel of claim 1, wherein the pressure vessel is arranged to be operable within a pressure range of up to about 600 MPa.

11. The pressure vessel of claim 1, wherein the pressure vessel is arranged to be operable within a pressure range above about 20 MPa.

12. A pressing arrangement for isostatic pressure treatment of articles, comprising
a pressure vessel as defined in claim 1, including a force-absorbing press frame provided around the force absorbing pressure vessel cylinder.
